(19) United States
(12) Patent Application Publication
(10) Pub. No.: US 2007/0163819 A1
(43) Pub. Date: Jul. 19, 2007

(54) HYBRID DRIVE SYSTEM AND METHOD OF INSTALLING SAME

(76) Inventors: Timothy Gerard Richter, Wynantskill, NY (US); Robert Dean King, Schenectady, NY (US); John David Dubeck, Louisville, KY (US)

Correspondence Address: PATRICK W. RASCHE (12552), ARMSTRONG TEASDALE LLP, ONE METROPOLITAN SQUARE, SUITE 2600, ST. LOUIS, MO, 63102-2740, US

(21) Appl. No.: 11/614,451

(22) Filed: Dec. 21, 2006

Related U.S. Application Data
(60) Provisional application No. 60/759,873, filed on Jan. 18, 2006.

(51) Int. Cl. B60K 6/00

(52) U.S. Cl. 180/65.2

(57) ABSTRACT

A hybrid drive system includes a motor coupled between a transmission and a differential, and a hybrid controller coupled to a vehicle such that the hybrid controller is mounted separately from an engine controller. A hybrid drive system including the above hybrid drive system, and a method of installing the hybrid drive system are also included herein.

### CROSS REFERENCE TO RELATED APPLICATIONS

This application is entitled to the benefit of, and claims priority to, provisional U.S. Patent Application Ser. No. 60/759,873 filed Jan. 18, 2006, and entitled “Hybrid Vehicle Control Technique”, which is hereby incorporated by reference in its entirety.

### BACKGROUND OF THE INVENTION

This invention relates generally to vehicle propulsion systems and, more particularly, to a hybrid control system that is installed in a conventional vehicle.

At least one known vehicle includes an internal combustion engine (ICE), a transmission that is coupled to the internal combustion engine, a differential, a drive shaft that is coupled between the differential and the transmission, and a pair of axles coupled to the differential that work in series to transfer power generated by the internal combustion engine to a wheel that is coupled to each respective axle.

As known, hybrid vehicles offer many advantages, the foremost being fuel efficiency. Specifically, hybrid vehicles also include additional components such as an electric drive system that works in combination with the internal combustion engine to achieve the increased fuel efficiency. To convert a conventional vehicle to a hybrid vehicle, significant changes are required to be performed on the vehicle chassis and the vehicle control system. For example, a hybrid vehicle includes a motor that is configured drive the wheels and also to operate as a generator when driven by the wheels. The hybrid vehicle also includes a controller to control power flow between the motor and a storage device.

One known method of converting a conventional vehicle to a hybrid vehicle includes integrating the controller utilized to control the hybrid components into the engine controller. While this method allows the modified engine controller to control both the engine components and the hybrid components, the engine or engine controller is often difficult to modify to support the newly installed hybrid components. More specifically, known engine controllers typically include a microprocessor to control the engine and vehicle functions. However, modifying the microprocessor requires specialized tools and knowledge generally proprietary to the vehicle manufacturer. As a result, it may be cost prohibitive or difficult to modify a conventional vehicle to a hybrid vehicle to take full advantage of the increased fuel efficiency of the hybrid vehicle system.

### BRIEF DESCRIPTION OF THE INVENTION

In one aspect, a method of retrofitting a vehicle that includes a heat engine, a transmission coupled to the heat engine, a differential coupled to the transmission, an engine controller coupled to the heat engine, and a plurality of sensors coupled to the engine controller is provided. The method includes coupling a motor between the transmission and the differential, coupling a hybrid controller to vehicle such that hybrid controller is separate from the engine controller, and coupling the hybrid controller to the motor to facilitate controlling the motor.

In another aspect, a hybrid drive system is provided. The hybrid drive system includes a motor coupled between a transmission and a differential, and a hybrid controller coupled to a vehicle such that the hybrid controller is mounted separately from an engine controller

In a further aspect, a hybrid vehicle is provided. The hybrid vehicle includes a heat engine, a transmission coupled to the heat engine, a differential coupled to the transmission, an engine controller coupled to the heat engine, a plurality of sensors coupled to the engine controller, and a hybrid drive system including a motor coupled between the transmission and the differential, and a hybrid controller coupled to the vehicle such that hybrid controller is mounted separately from the engine controller, the hybrid controller further coupled to the motor to facilitate controlling the motor.

### BRIEF DESCRIPTION OF THE DRAWINGS

FIG. 1 illustrates a conventional vehicle;

FIG. 2 illustrates an exemplary hybrid vehicle including an exemplary hybrid control system;

FIG. 3 illustrates exemplary hybrid vehicle including another exemplary hybrid control system;

FIG. 4 is a graphical illustration of the hybrid controller shown in FIG. 3 during normal operation;

FIG. 5 illustrates exemplary hybrid vehicle including another exemplary hybrid control system;

FIG. 6 is a simplified operational diagram of the hybrid controller shown in FIG. 5 during normal operation; and

FIG. 7 is a graphical illustration of the hybrid controller shown in FIG. 5 during normal operation.

### DETAILED DESCRIPTION OF THE INVENTION

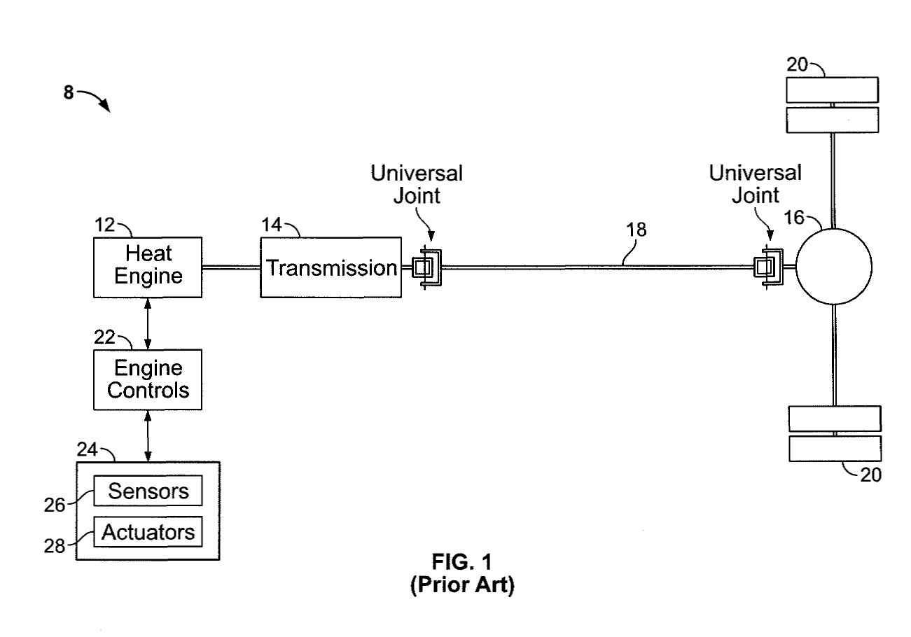

FIG. 1 illustrates a conventional vehicle 8 that includes a heat engine 12, a transmission 14 that is coupled to the engine 12, a differential 16, and at least one drive shaft 18 that is coupled between the transmission 14 and the differential 16. Vehicle 8 also includes at least two wheels 20 that are coupled to respective ends of the differential 16. In one embodiment, vehicle 8 is configured as a rear wheel drive vehicle such that differential 16 is positioned near the aft end of vehicle 8 and therefore configured to drive at least one of the wheels 20. Optionally, vehicle 8 may be configured as a front wheel drive vehicle. In the exemplary embodiment, heat engine 12 may be implemented using at least one of an internal combustion gasoline engine, an internal combustion diesel engine, an external combustion engine such as a steam engine, or any engine that utilizes natural gas, biofuel, or hydrogen in the combustion process. Moreover, vehicle as used herein represents any of a broad class of apparatuses that may be utilized to move an operator from a first location to a second location, and may include for example, trucks, buses, automobiles, cars and off-road vehicles, etc.

Vehicle 8 also includes an engine control system or engine controller 22 that is coupled to heat engine 12 and a plurality of sensors or actuators 24 that are coupled to engine controller 22. Engine controller 22 is a controller installed on a conventional vehicle, during the original fabrication of the vehicle, that is configured to transmit or receive data from the heat engine, but may also perform supervisory functions such as transmission shifting, accessory control, driver interface, and/or an electronically controlled braking system, for example. As such, the engine controller 22 may also referred to more broadly as a vehicle controller or vehicle control system.

As such, controller 22 is configured to receive inputs from a variety of sensors 26 and/or actuators 28 and provide a corresponding output to heat engine 12 and or transmission 14. For example, sensors 26 may include a temperature sensor, an rpm sensor, a torque sensor, and/or a speed sensor that are configured to sense the respective temperature, rpm, speed, torque, and/or heat engine 12 and/or transmission 14. Moreover, actuators 28 may include a throttle command signal generated by the operator depressing an accelerator pedal. During operation, engine controller 22 is configured to operate heat engine 12 and transmission 14 during all modes of operation.

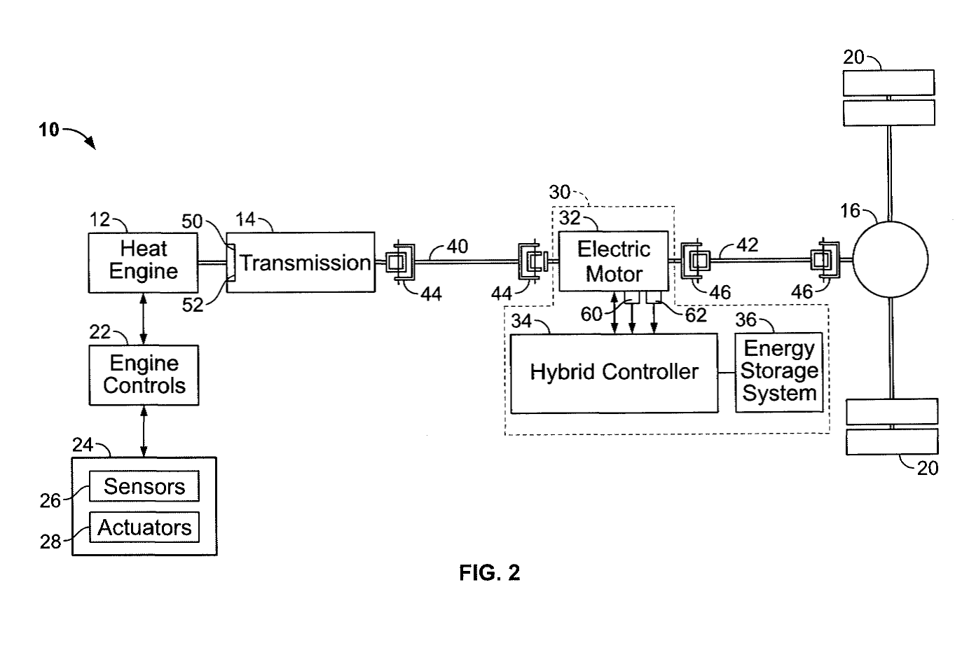

FIG. 2 illustrates an exemplary hybrid vehicle 10 that includes a first exemplary hybrid drive system 30. More specifically, the conventional vehicle 8 shown in FIG. 1 has been modified to include an exemplary hybrid drive system 30. Hybrid drive system 30 includes at least one electrical device 32 such as an electric motor/generator that is coupled between transmission 14 and differential 16, a hybrid control device 34 that is electrically coupled to electrical device 32, and an energy storage system 36 that is coupled to the hybrid control device 34. In the exemplary embodiment, the energy storage system comprises a plurality of batteries such as, but not limited to, sodium nickel chloride batteries, sodium sulfur batteries, a fuel cell, nickel metal hydride batteries, lithium ion batteries, lithium polymer batteries, nickel cadmium batteries, and/or lead acid batteries that are coupled together in a serial or parallel arrangement. Optionally, the energy storage system may include compressed air, hydraulic accumulators, ultracapacitors, thin film capacitors, a flywheel, or a wide variety of other energy storing materials or systems.

In the exemplary embodiment, illustrated in FIG. 2, the conventional vehicle 8 (shown in FIG. 1) is converted to a hybrid vehicle 10 by removing the conventional drive shaft 18 (shown in FIG. 1) and installing a first drive shaft 40, a second drive shaft 42, and two pairs of universal joints 44 and 46 to facilitate coupling electrical device 32 between transmission 14 and differential 16. In another embodiment, the electrical device 32 is coupled directly to transmission 14, and vehicle 10 includes at least one drive shaft 18 to couple the electrical device 32 to the differential 16. In still a further embodiment, the electrical device 32 is coupled directly to the differential 16, and vehicle 10 includes at least one drive shaft 18 to couple the electrical device 32 to the transmission 14.

In the exemplary embodiment, illustrated in FIG. 2, the first drive shaft 40 is coupled between the transmission 14 and the electrical device 32 using the first pair of universal joints 44, and the second drive shaft 42 is coupled between the electrical device 32 and the differential using the second pair of universal joints 46. As such, during some operations the electrical device 32 functions as a motor to receive substantially all the torque generated by the engine 12 through the transmission 14, the transmission output torque is summed with the torque produced by the electric motor and transmitted to the differential 16.

Moreover, during other operations, the electrical device 32 functions as a generator to receive substantially all the torque generated by the vehicle 10 through the differential 16. The phrase substantially all the torque, as used herein, represents the nominal torque that is generated by the engine 12 or transmission 14 when operating the first mode or the nominal torque that is generated by differential 16 when operating in the second mode, without representing minor mechanical or electrical losses that occur in a typical system. For example, internal losses caused by bearings, friction, or etc.

Although the exemplary embodiment illustrates a hybrid vehicle 10 that includes the electrical device 32 coupled between the transmission 14 and the differential 16, it should be realized that vehicle 10 may include a single wheeled axle for example that replaces differential 16. Accordingly, the electrical device 32 in the exemplary embodiment, is coupled between the driving portion, i.e. engine 12/transmission 14 and the driven portion, i.e. differential 16. Optionally, electrical device 32 includes a clutch (not shown) that may be utilized to decouple a portion of the electrical device 32 from the drivetrain during selected driving conditions. For example, when vehicle 10 is operating on a freeway, an operator may choose to declutch the electrical device 32 from the drive train to facilitate optimizing fuel efficiency. As such, the electrical device 32 may include a rotor shaft such that the electrical device 32 is still configured to transmit torque from the transmission 14 to the differential 16 as shown.

In one embodiment, transmission 14 is a manually operated transmission that includes a plurality of gears and a clutch 50, such that the input torque received from engine 12 is multiplied using the gear ratio(s) and transmitted to the electrical device 32. In another embodiment, transmission 14 is an automatic transmission having one or more discrete gear ratios and as such may include a torque converter 52. Optionally, transmission 14 is an automatically shifted manual transmission and includes clutch 50. In the exemplary embodiment, the transmission is an automatic transmission with gear ratios that vary from approximately 0.7:1 to 4:1 and includes a torque converter to couple the transmission to the engine with continuously variable gear ratio.

As discussed above, it is difficult to convert conventional vehicle 8 to hybrid vehicle 10 because the known engine controllers, i.e. engine controller 22 typically includes a microprocessor to control heat engine 12 and various other vehicle functions. However, modifying the microprocessor requires specialized tools and knowledge generally proprietary to the vehicle manufacturer.

As a result, in this embodiment, hybrid drive system 30 is not connected to engine controller 22. More specifically, in this embodiment, hybrid control drive 30 is configured to operate in a first mode described herein as the “Hands-off Mode”. In this arrangement, hybrid drive system 30 has the least impact on the engine controller 22. More specifically, the control of hybrid drive system 30 is based solely on inputs that are received from sensors installed into the vehicle as part of hybrid drive system 30. That is, hybrid controller 34 does not receive any inputs from engine controller 22 or other sensors installed on the conventional vehicle 8.

For example, in this embodiment, hybrid drive system 30 may include a speed sensor 60 and a tachometer 62, or any other additional sensors. The additional sensors installed onto the vehicle are coupled to hybrid controller 34 which utilizes this received information to calculate a torque command and generate a signal which is transmitted to electrical device 32 to control the speed and torque of electrical device 32. As such, hybrid drive system 30 is self-contained and does not interact or receive inputs from the engine controller 22, or sensors and actuators that are coupled to engine controller 22.

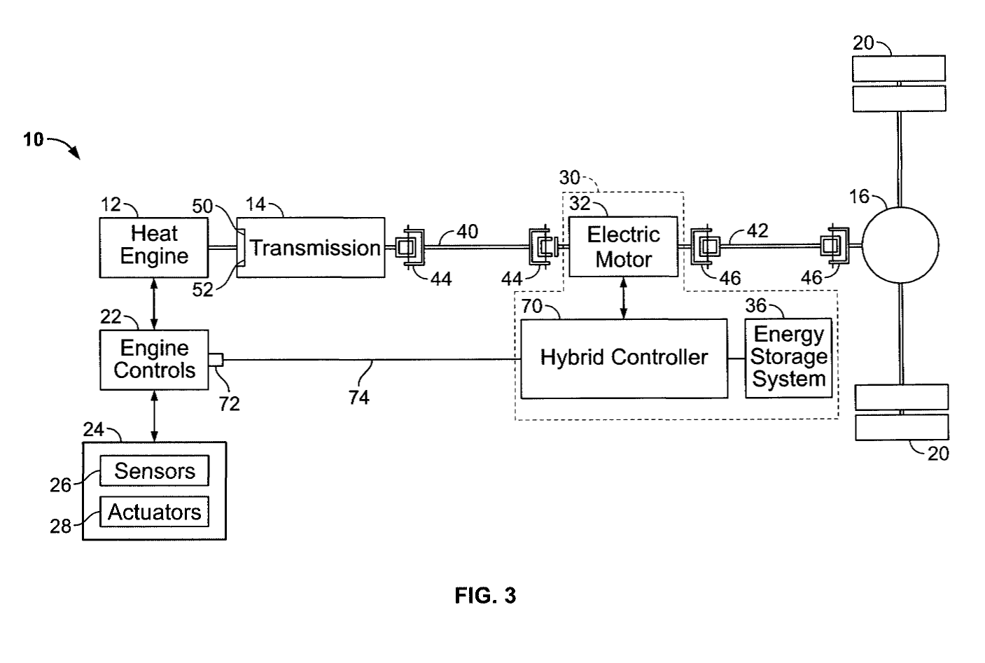

FIG. 3 illustrates the exemplary hybrid vehicle 10 shown in FIG. 2 that includes a second exemplary hybrid controller 70. More specifically, the conventional vehicle 8 shown in FIG. 1 has been modified to include exemplary hybrid drive system 30 which in this embodiment, includes another exemplary hybrid controller 70. In this embodiment, referred to herein as a “Listen-only Mode”, hybrid controller 70 is connected to engine controller 22. More specifically, in this embodiment, hybrid controller 70 is coupled to an onboard diagnostic port (OBD) port 72. The OBD port 72 is a diagnostic port that provides information regarding the vehicle state and condition, such as speed, engine rpm, among much other valuable data. Additionally, it should be realized that OBD port 72 is not part of hybrid drive system 30, but rather is a data port that is installed in the conventional engine controller 22 of all vehicles manufactured after 1995.

As such, data is extracted from OBD port 72 and transmitted to hybrid controller 70 via a communications bus 74. Hybrid controller 70 utilizes this received information, and any additional information provided from sensors installed with the hybrid control system, such as sensors 60 and/or 62 for example, to calculate a torque command. The calculated torque command is then transmitted by hybrid controller 70 to electrical device 32 to control the speed and torque of electrical device 32. During installation, hybrid controller 70 has the benefit of receiving information from existing data sensors utilizing OBD port 72. Accordingly, information that may be relatively difficult to obtain, such as internal engine operating parameters, such as ignition advance for example, can be utilized as a control input to the hybrid controller 70. As a result, in the Hands-off Mode, sensor functions installed with the conventional vehicle do not need to be duplicated, thus reducing the cost of installing the hybrid system described herein.

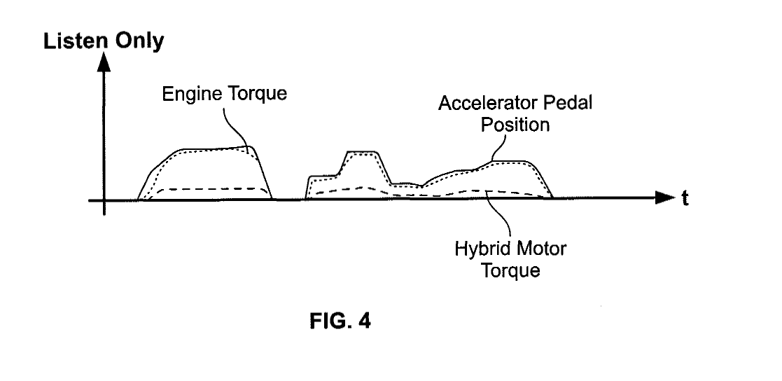

FIG. 4 is a graphical illustration of hybrid controller 70 during normal operation. As shown in FIG. 4, hybrid controller 70 does not affect the operation of engine controller 22. Rather, in the Hands-off Mode of operation, the accelerator pedal position (solid line), determined by actuator 28, is transmitted to hybrid controller 70. Hybrid controller 70 utilizes this signal to determine a proper torque setting of electrical device 32. Once this setting is determined, a signal is transmitted to electrical device 32. As shown in FIG. 4, as the hybrid motor torque (dashed line) increases, the vehicle operator feels the increase performance and will reduce the command generated by the accelerator pedal in response, thus reducing the engine contribution (dotted line) and decreasing fuel consumption.

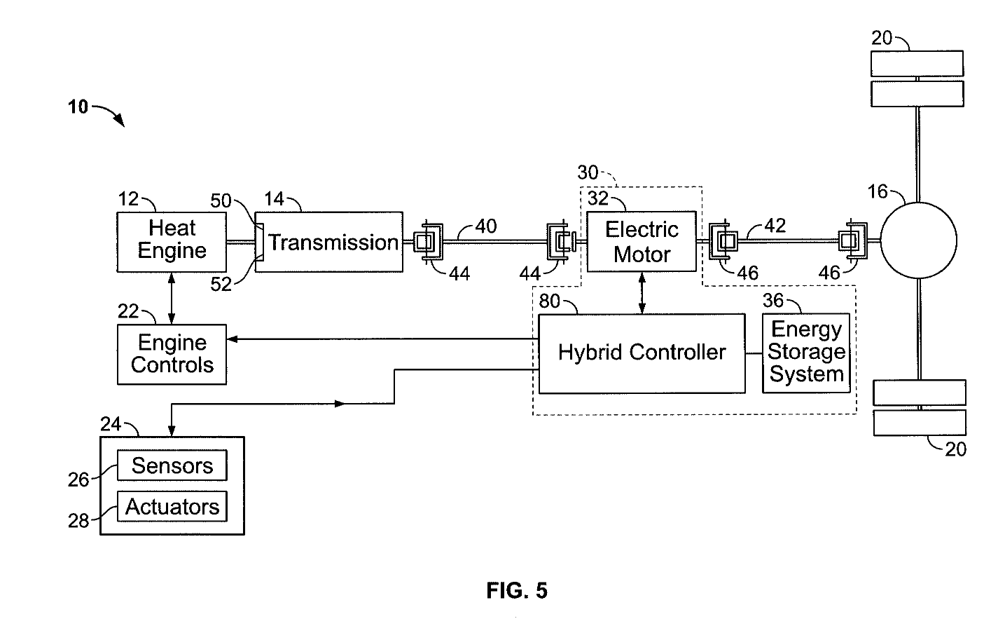

FIG. 5 illustrates the exemplary hybrid vehicle 10 shown in FIG. 2 that includes a third exemplary hybrid controller 80. More specifically, the conventional vehicle 8 shown in FIG. 1 has been modified to include exemplary hybrid drive system 30 which in this embodiment, includes another exemplary hybrid controller 80. In this embodiment, referred to herein as a “Control Mode”, the wiring of vehicle 8 has been modified to couple the existing sensors to hybrid controller 80. However, the engine controller 22 is not modified.

More specifically, in this embodiment, since the known vehicle utilizes sensors and control networks, such as the accelerator pedal, for example, a potentiometer attached to the accelerator pedal generates a variable electrical signal based on the pedal position. This signal is conditioned and converted to a digital representation that is communicated to the engine controller 22, and other vehicle components, on the vehicle communication network.

Moreover, the known vehicles also include a connector that is integral to the sensor/network interface. Control Mode takes advantage of this connector by disrupting the information connection between the engine controller 22 and the sensors 22, and transmitting the information generated by the sensors 22 directly to hybrid controller 80 where it is processed.

In this embodiment, the hybrid controller 80 includes a second interface to the engine controller 22 that stands in for the original sensor such that engine controller 22 does not see any difference in communication traffic. For example, in one exemplary embodiment, hybrid controller 80 intercepts the accelerator pedal signal 28. When vehicle 10 is operating in a non-hybrid mode, the hybrid controller 80 echoes all data generated by and/or sent to the accelerator pedal and engine controller 22. When vehicle 10 is operating in hybrid mode, hybrid controller 80 uses the accelerator pedal command to command torque from the system. More specifically, hybrid controller 80 is programmed with an algorithm that generates the proper balance of power sources (i.e. engine and energy storage unit) and sends the appropriate commands to those components.

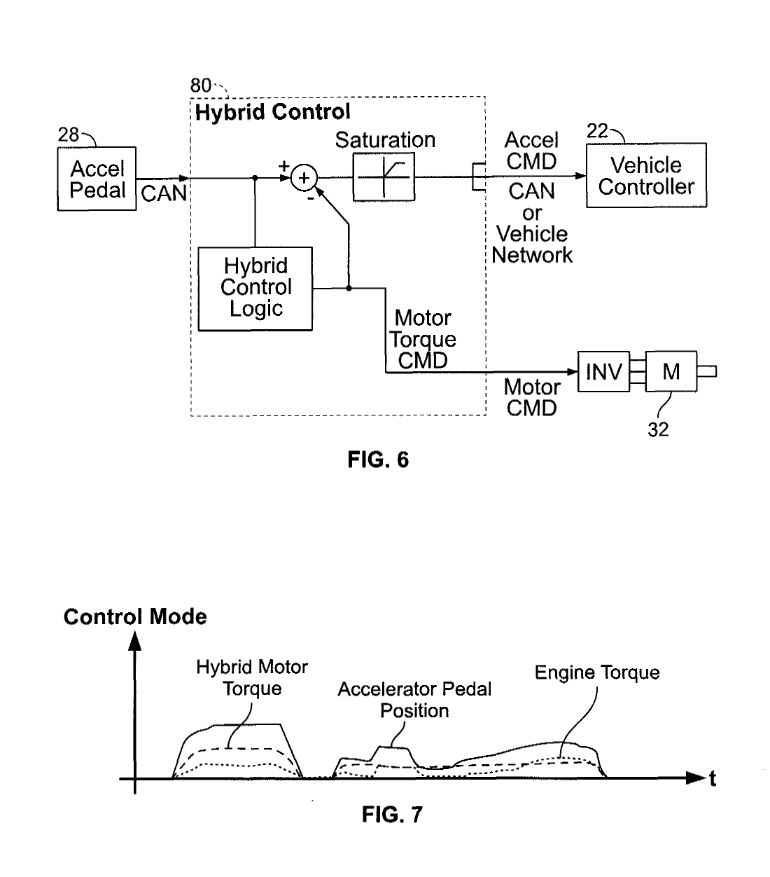

FIG. 6 is a simplified operational diagram of hybrid controller 70 during normal operation. As shown in FIG. 6, the accelerator pedal 28 is disconnected from engine controller 22 and reconnected to hybrid controller 80. In this arrangement, hybrid controller 80 determines a ratio of motor load and engine load to be applied to vehicle 10. The hybrid contribution is subtracted from the accelerator command and ensured to be non-negative using a saturation block. The modified accelerator command is the transmitted to engine controller 22.

FIG. 7 is a graphical illustration of hybrid controller 80 during the control mode of operation. As shown in FIG. 8, hybrid controller 80 interrupts the control signal transmitted by the accelerator pedal 28 (solid line). The based on the accelerator pedal position, hybrid controller 80 determines a ratio of hybrid torque (dashed line) and engine torque (dotted line) to be applied to vehicle 10, thus reducing the engine contribution and decreasing fuel consumption.

As discussed herein, hybrid controller 80 operating in a control mode allows a hybrid drive system 30 to be installed in any known vehicle with minimum modifications to the known vehicle. Moreover, the control mode technique described herein, may be applied to any or all of the sensors installed in a conventional vehicle including the accelerator pedal as described herein. Moreover, while FIGS. 5 and 6 infer that signals provided to hybrid controller 80 are electrical signals, it should be realized that hybrid controller 80 may also be configured to receive mechanical or analog signals. For example, a mechanical sensor may include an accelerator pedal that is linked through rods and/or cables to a throttle valve in a carburetor. A potentiometer may be attached to the mechanical linkage such that controller 70 would receive this signal from the engine controller 22 in the “Listen-only” mode. Optionally, the signal could be interrupted between the linkage and the engine controller 22 and routed to controller 80 for use in the “control mode”. In this embodiment, a motor or solenoid would replace the linkage at the carburetor to provide actuation of the throttle valve. Moreover, analog sensors may be similarly disconnected and routed to controller 80 and replaced, as discussed above. The hybrid controller 80 is capable of responding appropriately, just as the original sensor would, to all conditions, such as faults, and status requests.

Described herein is a plurality of hybrid controllers that may be implemented to convert a conventional vehicle to a hybrid vehicle. Specifically, described herein is a first hybrid controller that operates in a hands-off mode. In this mode, the hybrid controller does not utilize any signals that are provided to the engine controller. Rather, additional sensors are installed on the vehicle. The hybrid controller then utilizes these additional sensors to control the electric motor installed in the hybrid drivetrain.

In another embodiment, a second hybrid controller operates in a listen-only mode. In this mode, the hybrid controller is coupled to the OBD port of the engine controller. The hybrid controller then receives the data from the engine controller and transmits a control signal to the electric motor to control torque.

In another embodiment, a third hybrid controller operates in a control mode wherein signals are rerouted from the engine controller to the hybrid controller. The hybrid controller then assumes overall operations of the vehicle including the engine controller.

Each of the hybrid controllers described herein, may be implemented on a broad base of vehicles with little or no knowledge of the vehicle control software, hardware or algorithms. This provides for a foundation of lower cost implementation and less engineering work to custom design vehicle controls specific to hybrid implementations.

A method of retrofitting a vehicle that includes a heat engine, a transmission coupled to the heat engine, a differential coupled to the transmission, an engine controller coupled to the heat engine, and a plurality of sensors coupled to the engine controller, includes coupling a motor between the transmission and the differential, coupling a hybrid controller to vehicle such that hybrid controller is separate from the engine controller, and coupling the hybrid controller to the motor to facilitate controlling the motor.

While the invention has been described in terms of various specific embodiments, those skilled in the art will recognize that the invention can be practiced with modification within the spirit and scope of the claims.

What is claimed is:

1. A method of retrofitting a vehicle that includes a heat engine, a transmission coupled to the heat engine, a differential coupled to the transmission, an engine controller coupled to the heat engine, and a plurality of sensors coupled to the engine controller, said method comprising:
coupling a motor between the transmission and the differential;
coupling a hybrid controller to vehicle such that hybrid controller is separate from the engine controller; and
coupling the hybrid controller to the motor to facilitate controlling the motor.

2. A method in accordance with claim 1, further comprising coupling the hybrid controller to vehicle such no modifications are made to the engine controller or the plurality of sensors.

3. A method in accordance with claim 1, wherein said vehicle further includes an onboard data port, said method further comprising coupling the hybrid controller to the onboard data port such that the hybrid controller receives at least some of the data transmitted from the onboard data port and such that the hybrid controller does not modify any signals sent to the engine controller.

4. A method in accordance with claim 1, further comprising:
disconnecting at least one of the plurality of sensors from the engine controller; and
coupling the at least one sensor to the hybrid controller such that data transmitted from the at least one sensor is transmitted directly to the hybrid controller.

5. A method in accordance with claim 4, further comprising:
installing a replacement sensor to replace the disconnected sensor; and
coupling the replacement sensor to the engine controller.

6. A method in accordance with claim 1, further comprising:
disconnecting an accelerator pedal position sensor from the engine controller;
coupling the accelerator pedal position sensor to the hybrid controller; and
coupling a replacement accelerator pedal position sensor to the engine controller.

7. A method in accordance with claim 6, further comprising coupling a hybrid controller including a microprocessor to the vehicle, wherein the microprocessor is configured to determine an engine load subtract command, determine a load on the electric motor, determine a position of the accelerator pedal, and transmit a signal to the motor based on the engine load subtract command, the load on the electric motor, and the accelerator pedal position.

8. A method in accordance with claim 1 wherein said vehicle further includes at least one drive shaft coupled between the transmission and the differential, said method further comprising
removing at least one drive shaft; and
coupling the electrical device between the transmission and the differential such that during a first mode of operation the electrical device functions as a motor to receive substantially all the load generated by the engine through the transmission, and such that during a second mode of operation the electrical device functions as a generator to receive substantially all the load generated by the differential.

9. A hybrid drive system for a vehicle that includes a heat engine, a transmission coupled to the heat engine, a differential coupled to the transmission, an engine controller coupled to the heat engine, and a plurality of sensors coupled to the engine controller, said hybrid drive system comprising:
a motor coupled between the transmission and the differential; and
a hybrid controller coupled to the vehicle such that said hybrid controller is mounted separately from the engine controller, said hybrid controller is further coupled to said motor to facilitate controlling said motor.

10. A hybrid drive system in accordance with claim 9, wherein the vehicle further includes an onboard data port, said hybrid drive coupled to said onboard data port such that said hybrid controller receives substantially all of the data transmitted from the onboard data port and such that said hybrid controller does not modify any signals sent to the engine controller.

11. A hybrid drive system in accordance with claim 8, wherein at least one of the plurality of sensors is coupled directly to said hybrid controller.

12. A hybrid drive system in accordance with claim 8, further comprising a connector disposed between at least one of the plurality of sensors, said connector comprising a first output coupled to the engine controller and a second output coupled to said hybrid controller.

13. A hybrid drive system in accordance with claim 8, wherein said hybrid controller further comprises a microprocessor configured to determine an engine load subtract command, determine a load on the electric motor, determine a position of the accelerator pedal, and transmit a signal to the motor based on the engine load subtract command, the load on the electric motor, and the accelerator pedal position.

14. A hybrid vehicle comprising:
a heat engine;
a transmission coupled to said heat engine;
a differential coupled to said transmission;
an engine controller coupled to said heat engine;
a plurality of sensors coupled to said engine controller; and
a hybrid drive system comprising
a motor coupled between the transmission and the differential; and
a hybrid controller coupled to the vehicle such that hybrid controller is mounted separately from the engine controller, said hybrid controller further coupled to said motor to facilitate controlling said motor.

15. A hybrid vehicle in accordance with claim 14, wherein the vehicle further includes an onboard data port, said hybrid drive coupled to said onboard data port such that said hybrid controller receives substantially all of the data transmitted from the onboard data port and such that said hybrid controller does not modify any signals sent to the engine controller.

16. A hybrid vehicle in accordance with claim 14, wherein at least one of the plurality of sensors is coupled directly to said hybrid controller.

17. A hybrid vehicle in accordance with claim 14, further comprising a connector disposed between at least one of the plurality of sensors, said connector comprising a first output coupled to the engine controller and a second output coupled to said hybrid controller.

18. A hybrid vehicle in accordance with claim 14, wherein said hybrid controller further comprises a microprocessor configured to determine an engine load subtract command, determine a load on the electric motor, determine a position of the accelerator pedal, and transmit a signal to the motor based on the engine load subtract command, the load on the electric motor, and the accelerator pedal position.

19. A hybrid vehicle in accordance with claim 14, further comprising:
a first drive shaft coupled between said motor and said transmission; and
a second drive shaft coupled between said motor and said differential.

20. A hybrid vehicle in accordance with claim 14, wherein said motor is coupled between said transmission and said differential such that during a first mode of operation the electrical device functions as a motor to receive substantially all the torque generated by the engine through the transmission, and such that during a second mode of operation the electrical device functions as a generator to receive substantially all the torque generated by the differential.

21. A hybrid vehicle in accordance with claim 14, further comprising an energy storage system electrically coupled to said hybrid controller such that the power output from the energy storage system is transmitted to said motor during predetermined operating conditions.

22. A method in accordance with claim 1, further comprising:
disconnecting at least one sensor from the vehicle; and
coupling the at least one sensor to the hybrid controller such that data transmitted from the at least one sensor is transmitted directly to the hybrid controller.
